(19) United States
(12) Patent Application Publication
(10) Pub. No.: US 2009/0077021 A1
(43) Pub. Date: Mar. 19, 2009

(54) System for Managing SameAs Relationships Between Ontology Instances and Method for the Same

(75) Inventors: Han Min Jung, Daejeon (KR); Pyung Kim, Daejeon (KR); In Su Kang, Gyeongsangbuk-Do (KR); Seoung Woo Lee, Daejeon (KR); Mi Kyung Lee, Gyeongsangbuk-Do (KR); Won Kyung Sung, Daejeon (KR); Dong In Park, Seoul (KR)

Correspondence Address: STEPTOE & JOHNSON LLP, 1330 CONNECTICUT AVENUE, N.W., WASHINGTON, DC, 20036, US

(73) Assignee: Korea Institute of Science & Technology Information, Daejeon (KR)

(21) Appl. No.: 11/576,442

(22) PCT Filed: Dec. 18, 2006
(86) PCT No.: PCT/KR2006/005535

§ 371 Date: Mar. 30, 2007

(30) Foreign Application Priority Data
Nov. 21, 2006 (KR) 10-2006-0114957

(51) Int. Cl. G06F 7/06; G06F 17/30

(52) U.S. Cl. 707/3; 707/E17.014

(57) ABSTRACT

A system for managing sameAs relationships between ontology instances comprises a sameAs relationship managing unit that checks, sets, or cancels sameAs relationships between ontology instances; a sameAs group knowledge processing unit that receives an input for setting or canceling sameAs relationships from the sameAs relationship managing unit and then corrects related knowledge within ontology instance data; and a sameAs inference service providing unit that uses the knowledge corrected by the sameAs group knowledge processing unit, processes a user query, and performs sameAs post-processing so as to present the result.

### TECHNICAL FIELD

The present invention relates to a system for managing sameAs relationships between ontology instances and a method for the same, which can be used in all fields including the Semantic Web which need to provide a knowledge service by using sameAs relationships between ontology instances.

### BACKGROUND ART

In general, ontology is a knowledge system for defining the relationship between classes (concepts) to be shared in a specific region, the ontology being composed of ontology schemas and ontology instances. The ontology schema can be referred to as a frame (for example, a concept of ‘person’ is connected to ‘an agency’ through the relationship of ‘belongingness’) for representing the relationship between concepts. The ontology instance can be referred to as an example of a specific concept or a connection between concepts (for example, ‘Mr. Jung’ is an object of a class of ‘person’ and is connected to ‘KISTI (Korea Institute of Science and Technology Information)’ through the relationship of ‘belongingness’, the KISTI being an object of a class of ‘agnecy’).

In terms of managing ontology instance data, when two different objects (for example, ‘Mr. Hong’ of ‘Seoul Univ.’ and ‘Mr. Hong’ of ‘Korea Science and Engineering Foundation’) are found to be identical, a sameAs relationship needs to be set, the sameAs relationship meaning that two objects are the same as each other. On the contrary, when an error in the previous judgment of sameAs relationship is found, the sameAs relationship needs to be canceled. The setting/canceling of sameAs relationship is essentially required for managing the matching between ontology objects. The setting/canceling of sameAs relationship can be performed in integrating ontology instances in more than two similar/same fields or in single ontology.

Conventionally, however, a system for managing sameAs relationships and a method for the same, which are related to the setting/canceling of sameAs relationships between ontology instances, have not been developed.

### DISCLOSURE

### Technical Problem

An advantage of the invention is that it provides a system for managing sameAs relationships between ontology instances and a method for the same, which manages sameAs relationships between ontology objects, corrects knowledges related to the setting/canceling of sameAs relationship in ontology instance data, processes a user query, and performs sameAs post-processing so as to present the result, thereby configuring a sameAs management framework which is stable and effective in all fields which need to provide an inference service using the Semantic Web technique.

### Technical Solution

According to an aspect of the invention, a system for managing sameAs relationships between ontology instances comprises a sameAs relationship managing unit that checks, sets, or cancels sameAs relationships between ontology instances; a sameAs group knowledge processing unit that receives an input for setting or canceling sameAs relationships from the sameAs relationship managing unit and then corrects related knowledge within ontology instance data; and a sameAs inference service providing unit that uses the knowledge corrected by the sameAs group knowledge processing unit, processes a user query, and performs sameAs post-processing so as to present the result.

According to another aspect of the invention, a method for managing sameAs relationships between ontology instances comprises checking, setting, or canceling sameAs relationships between ontology instances; receiving an input for the setting or canceling of the sameAs relationships and then correcting related knowledge within ontology instance data; and using the corrected knowledge, processing a user query, and performing sameAs post-processing so as to present the result.

### ADVANTAGEOUS EFFECTS

The system for managing sameAs relationships between ontology instances and the method for the same according to the invention manages sameAs relationships between ontology objects, corrects knowledges related to the setting/canceling of sameAs relationship in ontology instance data, processes a user query, and performs sameAs post-processing so as to present the result, thereby configuring a sameAs management framework which is stable and effective in all fields which need to provide an inference service using the Semantic Web technique. Then, it is possible to achieve the common use of the Semantic Web service.

### DESCRIPTION OF DRAWINGS

FIG. 1 is a block diagram illustrating a system for managing sameAs relationships between ontology instances according to an embodiment of the present invention.

FIG. 2 is a flow chart showing a method for managing sameAs relationships between ontology instances according to an embodiment of the invention.

FIG. 3 is a diagram showing an example of a sameAs relationship managing unit shown in FIG. 1.

FIG. 4 is a diagram showing an example of a sameAs relationship setting section and a sameAs relationship canceling section shown in FIG. 1.

FIG. 5 is a diagram showing an example of a sameAs group knowledge processing unit shown in FIG. 1.

FIG. 6 is a diagram showing an example of a sameAs inference service providing unit shown in FIG. 1.

### BEST MODE

Hereinafter, a system for managing sameAs relationships between ontology instances and a method for the same according to an embodiment of the present invention will be described with reference to the drawings.

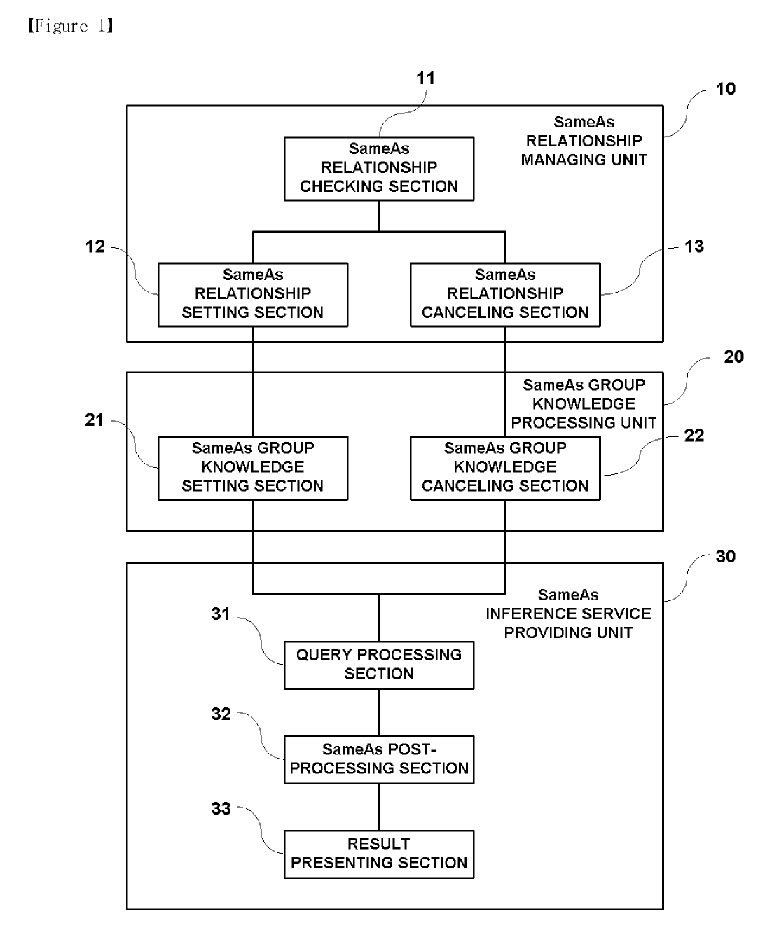

FIG. 1 is a block diagram illustrating a system for managing sameAs relationships between ontology instances according to an embodiment of the invention.

As shown in FIG. 1, the system includes a sameAs relationship managing unit 10 which checks, sets, or cancels sameAs relationships between ontology instances; a sameAs group knowledge processing unit 20 which receives an input for setting or canceling sameAs relationships from the sameAs relationship managing unit 10 and then corrects related knowledge within ontology instance data; and a sameAs inference service providing unit 30 which uses the knowledge corrected by the sameAs group knowledge processing unit 20, processes a user query, and performs sameAs post-processing so as to present the result.

The sameAs relationship managing unit 10 checks an object pair in which a sameAs relationship is already set, sets a new sameAs relationship on an arbitrary object pair, and cancels the sameAs relationship which has been already set. In a word, the sameAs relationship managing unit 10 is in charge of managing a sameAs relationship.

The sameAs relationship managing unit 10 includes a sameAs relationship checking section 11 which checks sameAs object pairs and sameAs groups, which are obtained from the sameAs relationships set within ontology; a sameAs relationship setting section 12 which sets a new sameAs relationship on an arbitrary object pair; and a sameAs relationship canceling section 13 which cancels the sameAs relationship set by the sameAs relationship setting section 12.

The sameAs relationship checking section 11 provides a screen interface for searching object pairs in which sameAs relationships are already set, a screen interface for outputting sameAs object pairs, a screen interface for outputting objects bound in the sameAs relationship for each sameAs group, and a screen interface for displaying a URI (Uniform Resource Locator) of a sameAs object such that the domain of the object bound in the sameAs relationship can be checked.

The sameAs relationship setting section 12 provides a screen interface for receiving URIs of two objects, which are to establish a sameAs relationship, from a user and outputting a relationship between the objects or attributes of the objects such that the identity of a sameAs candidate object can be checked; a screen interface for designating a representative object among the sameAs candidate objects which are inputted by the user; a screen interface for verifying whether or not the consistency of instances is broken when the sameAs candidate objects inputted by the user are bound in a sameAs relationship (for example, when ontology instance data includes knowledges of A-hasBirthPlace-C, B-hasBirthPlace-D, and C-hasBirthPlace-D, and if a relationship of A-sameAs-B is set, the consistency of instances is not maintained) and then outputting the result; and a screen interface for outputting an appropriate error message with respect to an inappropriate request of a user for the setting of sameAs relationship. Further, the sameAs relation setting section 12 generates a sameAs triple in which an object designated as a representative object among the sameAs candidate objects inputted by the user is set to a subject of the sameAs relationship and the other objects are set to objects.

The sameAs relationship canceling section 13 provides a screen interface for selecting a sameAs object pair, of which the sameAs relationship is to be canceled, among the sameAs object pairs in which the sameAs relationships have been already established by the sameAs relationship checking section 11 and then outputting a relationship between two objects of the selected sameAs object pair or attributes of the objects such that the identities of objects between which the sameAs relationship is to be broken can be checked; and a screen interface for verifying whether or not the consistency of ontology instances is broken when the sameAs relationship of the sameAs object pair inputted by the user is broken and then outputting the result. Further, the sameAs relationship canceling section 13 eliminates a sameAs triple related to the sameAs object pair of which the sameAs relationship is to be canceled.

The sameAs group knowledge processing unit 20 receives an input for setting the sameAs relationship of an object pair from the sameAs relationship setting section 12 of the sameAs relationship managing unit 10 and then corrects knowledges related to two objects which are to establish a sameAs relationship. Further, the sameAs knowledge processing unit 20 receives an input for canceling the sameAs relationship of an object pair from the sameAs relationship canceling section 13 of the sameAs relationship managing unit 10 and then corrects knowledges related to two objects between which the relationship is to be canceled.

The sameAs group knowledge processing unit 20 includes a sameAs group knowledge setting section 21 which receives an input for setting the sameAs relationship of an object pair from the sameAs relationship setting section 12 of the sameAs relationship managing unit 10 and then corrects knowledges related to a sameAs group including two objects which are to establish a sameAs relationship; and a sameAs group knowledge canceling section 22 which receives an input for canceling the sameAs relationship of an object pair from the sameAs relationship canceling section 13 of the sameAs relationship managing unit 10 and then corrects knowledges related to a sameAs group including two objects between which the sameAs relationship is canceled.

The sameAs group knowledge setting section 21 corrects the knowledge of a representative object of a sameAs group which is changed when the sameAs relationship setting section 12 of the sameAs relationship managing unit 10 sets a new sameAs relationship, and the sameAs group knowledge canceling section 22 corrects the knowledge of a representative object of a sameAs group which is changed when the sameAs relationship setting section 12 of the sameAs relationship managing unit 10 cancels a sameAs relationship.

The sameAs group knowledge setting section 21 receives an input of sameAs objects (designated as A and B in this paragraph) and a sameAs representative object (designated as A in this paragraph), which are converted into a sameAs triple by the sameAs relationship setting section 12, and then searches representative objects of sameAs groups to which A and B respectively belong (for example, when a representative object is represented as a subject in the sameAs relationship, and if there are sameAs relationships such as a1-sameAs-a2, a2-sameAs-a3, and a3-sameAs-a4, a sameAs group to which a4 belongs is [a1, a2, a3, a4], and a representative object of the group is a1). Because of the sameAs grouping, some of attributes owned by a representative object of the group to which B belongs should be accumulated into corresponding attributes of a representative object of the group to which A belongs.

The sameAs group knowledge canceling section 22 receives an input of sameAs objects (designated as A and B in this paragraph), between which the sameAs relationship is canceled by the sameAs relationship canceling section 12, and a representative object (corresponding to a subject of a sameAs triple and designated as A in this paragraph) when the sameAs relationship is set, and then searches representative objects of the sameAs groups to which A and B respectively belong (for example, when a representative object is represented as a subject in the sameAs relationship, and if there are sameAs relationships such as a1-sameAs-a2, a2-sameAs-a3, and a3-sameAs-a4, a sameAs group to which a4 belongs is [a1, a2, a3, a4], and a representative object of the group is a1). Because of the cancellation of sameAs grouping, some of attributes owned by a representative object of the group to which B belongs should be subtracted from corresponding attributes of a representative object of the group to which A belongs.

The sameAs inference service providing section 30 uses the knowledge of the sameAs group knowledge group processing unit 20, receives a user query so as to generate the processing result, performs post-processing in which individual objects shown in the query-processed result are substituted with a representative object of the sameAs group to which the corresponding objects belong, and generates an output message of the post-processing result such that the output message is fitted to a user interface.

The sameAs inference service providing section 30 includes a query processing section 31 which processes a user query, a sameAs post-processing section 32 which performs sameAs post-processing on the query-processed result from the query processing section 31; and a result presenting section 33 which processes the sameAs post-processing result into a format to be requested in an inference service interface and then outputs the result.

The query processing section 31 receives a user query so as to generate a processing result and then delivers the processing result to the sameAs post-processing section 32.

The sameAs post-processing section 32 searches a sameAs group connected in the sameAs relationship with respect to individual objects shown in the query-processed result from the query processing section 31, searches a representative object of the sameAs group, and substitutes the objects with the representative object.

The result presenting section 33 receives the result from the sameAs post-processing section 32 and then generates an output message such that the output message is fitted to a user interface.

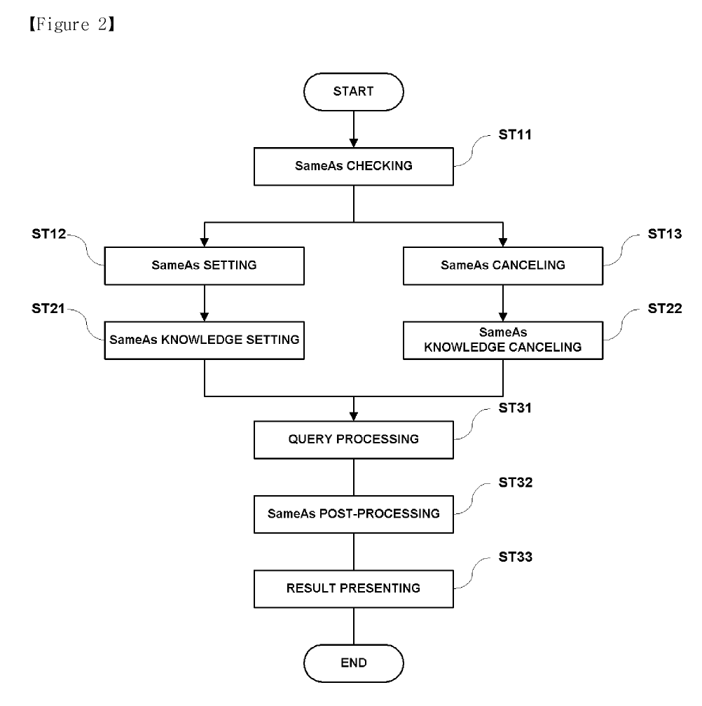

FIG. 2 is a flow chart showing a method for managing sameAs relationships between ontology instances according to an embodiment of the invention.

As shown in FIG. 2, the method includes a first step of checking, setting, or canceling sameAs relationships between ontology instances (ST11 to ST13); a second step of receiving an input for the setting or canceling of the sameAs relationships and then correcting related knowledge within ontology instance data (ST21 and ST22); and a third step of using the corrected knowledge, processing a user query, and performing sameAs post-processing so as to present the result (ST31 to ST33).

In the first step, an object pair in which a sameAs relationship is already set is checked, a new sameAs relationship is set on an arbitrary object pair, and the relationship which has been already set is canceled.

The first step includes an eleventh step (ST11) of checking sameAs object pairs and sameAs groups to be obtained from sameAs relationships which are already set within ontology; a twelve step (ST12) of setting a new sameAs relationship on an arbitrary object pair; a thirteenth step (ST13) of canceling the sameAs relationship of a sameAs object pair which have been already set.

In the eleventh step (ST11), there are provided a screen interface for searching object pairs in which existing sameAs relationships are already set, a screen interface for outputting sameAs object pairs, a screen interface for outputting objects bound in a sameAs relationship for each sameAs group, and a screen interface for displaying URIs of sameAs objects such that the domain of the objects bound in a sameAs relationship can be checked.

In the twelfth step (ST12), a new sameAs relationship is set on an arbitrary object pair or sameAs groups to which two objects respectively belong.

In the thirteenth step (ST13), the sameAs relationship of a sameAs object pair which has been already set is canceled.

In the second step, an input of the sameAs relationship of the object pair, which is set in the twelfth step (ST12), is received so as to correct knowledges related to two objects which are to establish a sameAs relationship. Further, an input of the sameAs relationship of the object pair, which is canceled in the thirteenth step (ST13), is received so as to correct knowledges related to two objects between which the sameAs relationship is to be canceled.

The second step includes a 21st step (ST21) of receiving an input of the sameAs relationship of the object pair, which is set in the twelfth step (ST12), and then correcting knowledges related to two objects which are to establish a sameAs relationship; and a 22nd step (ST22) of receiving an input of the sameAs relationship of the object pair, which is canceled in the thirteenth step (ST13), and then correcting knowledges related to two objects between which the sameAs relationship is to be canceled.

In the 21st step, an input of the sameAs relationship of the object pair, which is set in the twelfth step (ST12), is received so as to correct knowledge related to two objects which are to establish a sameAs relationship.

In the 21st step, an input of the sameAs relationship of the object pair, which is set in the twelfth step (ST12), is received so as to search representative objects of sameAs groups with respect to two objects which are to establish a sameAs relationship, and knowledges related to the searched representative objects of the sameAs groups are corrected.

In the 22nd step, an input of the sameAs relationship of the object pair, which is canceled in the thirteenth step (ST13), is received so as to correct knowledges related to two objects between which the sameAs relationship is to be canceled.

In the 22nd step, an input of the sameAs relationship of the object pair, which is canceled in the thirteenth step (ST13), is received so as to search representative objects of sameAs groups with respect to two objects between which the relationship is to be canceled, and knowledges related to the searched representative objects of the sameAs groups are corrected.

In the third step, a user query is received so as to generate the query-processed result, post-processing is performed in which individual objects shown in the query-processed result are substituted with a representative object of the sameAs group to which the corresponding objects belong, and an output message of the post-processing result is generated so as to be fitted to a user interface.

The third step includes a 31st step (ST31) of receiving a user query so as to generate the query-processed result; a 32nd step (ST32) of searching a sameAs group connected in the sameAs relationship with respect to individual objects shown in the query-processed result, searching a representative object of the sameAs group, and substituting the objects with the searched representative object; and a 33rd step (ST33) of receiving the result of the 32nd step and then generating an output message such that the output message is fitted to a user interface.

In the 31st step, a user query is received so as to generate the query-processed result.

In the 32nd step, a sameAs group connected in the sameAs relationship with respect to individual objects shown in the query-processed result is searched, a representative object of the sameAs group is searched, and the objects are substituted with the searched representative object.

In the 33rd step, the result of the 32nd step is received so as to generate an output message such that the message is fitted to a user interface defined in an inference service.

Hereinafter, the system for managing outcome information based on URI and the method for the same will be described in detail with reference to the drawings. When it is judged that the specific description of related known function or constitution can cloud the point of the invention, the description will be omitted. Terms to be described below are defined in consideration of the functions of the invention and can differ in accordance with the intension of a user or operator or the practice. Accordingly, the meanings of the terms should be interpreted on the basis of the contents of the specification.

An advantage of the invention is that it provides a sameAs management framework which is stable and effective in all fields to which an inference service using a Semantic Web technique needs to be provided. In the inference service, sameAs relationships between ontology instances are managed, sameAs relationships in ontology instance data are set and canceled, related knowledges are corrected, a user query is processed, and sameAs post-processing is performed so as to present the result.

In the invention, there will be described a method of implementing a sameAs management framework in view of object matching management in ontology which attracts a lot of attention with the development of the Semantic Web technique. The invention roughly includes a method of managing a sameAs relationship between objects by using ontology schema and instance data, a method of correcting the knowledge of a sameAs group which is changed by the setting or cancellation of sameAs relationship, and a method of processing a user query and performing sameAs post-processing.

A sameAs relationship is used to represent such a meaning that two different objects A and B individually exist but are the same objects as a matter of fact. More specifically, when two different objects A and B existing in ontology are determined to be identical in the real world, the objects are represented as a triple type like “A sameAs B” by using a connection word of “sameAs”. Conceptually, there is no priority between two objects bound in the sameAs relationship. In the invention, however, a representative object and a non-representative object are tacitly discriminated in a sameAs object pair. That is, the form of a sameAs triple such as A-sameAs-B is maintained as it is, but a principle where a subject A has priority to an object B or an object B has priority to a subject A is set up so as to discriminate a representative object and a non-representative object. In the invention, a subject is designated as a representative object, and an object is designated as a non-representative object.

Objects bound in the sameAs relationship form a sameAs group. When there are more than two related sameAs relationships, the number of objects to be included in the sameAs group increases (for example, sameAs relationships of A-sameAs-B, B-sameAs-C, and D-sameAs-E form two sameAs groups of [A, B, C] and [D, E]). The discrimination of representative object and non-representative object in a single sameAs relationship is extended to a concept of representative object and non-representative object in a sameAs group (in the above-described example, a representative object of the sameAs group [A, B, C] is A, and a representative object of the sameAs group [D, E] is D).

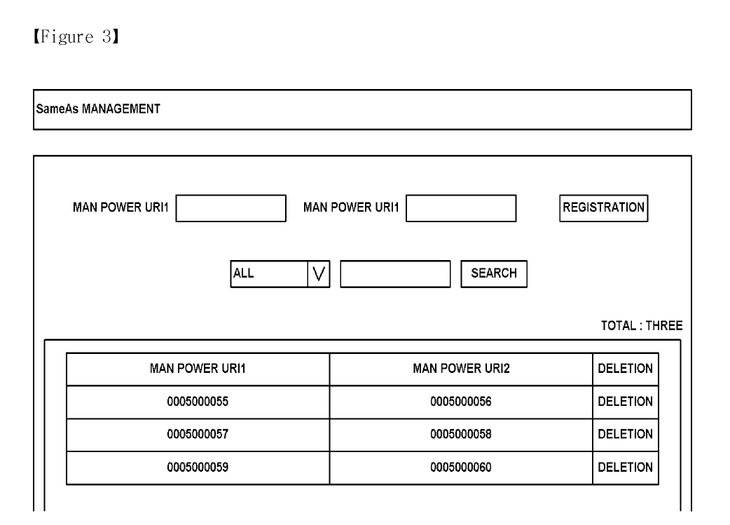

The sameAs relationship checking section 11 serves to check sameAs groups to be obtained from a single sameAs relationship and a plurality of connected sameAs relationships which are already set in ontology (refer to FIG. 3).

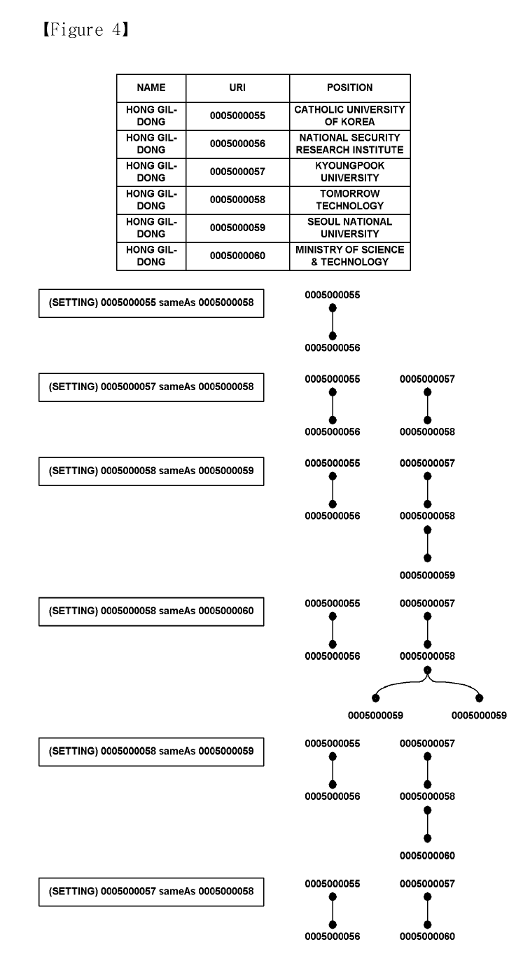

The sameAs relationship setting section 12 serves to set a sameAs relationship with respect to two objects represented by URI, and the sameAs relationship canceling section 13 serves to cancel a sameAs relationship with respect to two objects represented by URI (refer to FIG. 4). When a sameAs relationship is set or canceled, a preliminary operation is required, in which it is checked whether the setting or canceling of a specific sameAs relationship spoils the consistency of ontology or not. For example, when ontology instance data represented as a triple includes knowledges of A-hasBirthPlace-C, B-hasBirthPlace-D, and C-differentFrom-D, and if a sameAs relationship such as A-sameAs-B between two objects A and B is set, a relationship of C-sameAs-D can be inferred from the relationship of A-sameAs-B, because every person has a unique birthplace. Further, since the relationship of C-sameAs-D counters with the knowledge of C-differentFrom-D, the consistency of instances is not maintained. The sameAs relationship setting section needs to output an appropriate error message with respect to an inappropriate request of a user for the setting of sameAs relationship. For example, if a sameAs-relationship setting request to bind two objects B and C is made in a state where sameAs relationships such as A-sameAs-B, B-sameAs-C, and C-sameAs-D are already present, the sameAs setting request is inappropriate.

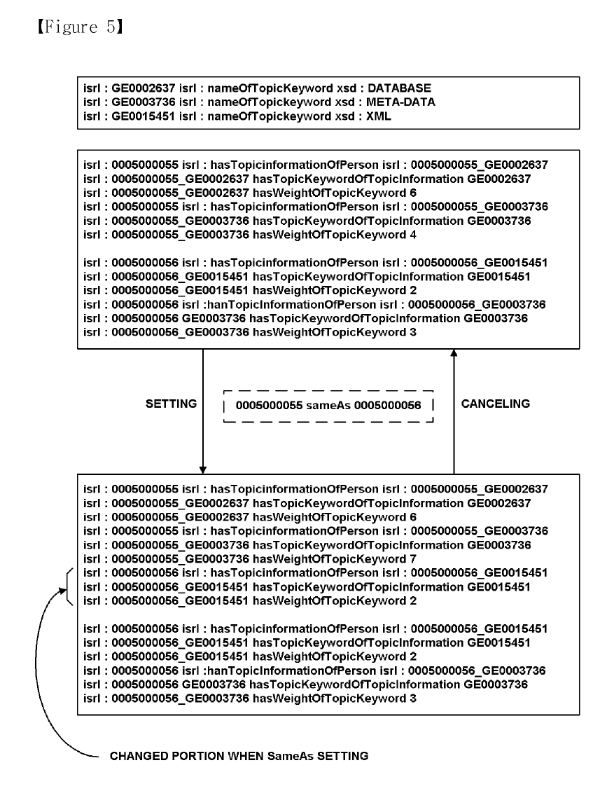

The sameAs group knowledge setting section 21 serves to set knowledge of a sameAs group which is to be changed by the setting of sameAs relationship, and the sameAs group knowledge canceling section 22 serves to cancel knowledge of a sameAs group which is to be changed by the canceling of sameAs relationship (refer to FIG. 5). In the invention, the knowledge of a sameAs group is defined as attributes owned by a representative object of the sameAs group. Therefore, the representative object of the sameAs group should have an attribute representing attributes of all objects, which belong to the corresponding sameAs group, for each type of attribute. For example, when there exist ontology instance data which are allocated by automatically extracting top-three research fields of a researcher from the original documents of papers written by the researcher, and if a sameAs relationship of A-sameAs-B, in which a researcher A is set to a representative between two researchers A and B who are present within ontology and have the same name, is set, top-three research fields for the sameAs group [A, B] should be once again searched on the overall papers of the researchers A and B. In this case, it is highly likely that a calculation amount which cannot guarantee a real-time response rate is requested. In the invention, the sameAs group knowledge setting section 21 is configured so as to undertake a burden of calculation with respect to attributes owned by the representative object of the sameAs group, which are made by the setting of sameAs relationship. Therefore, a real-time response rate of the ontology-based inference system related to the sameAs processing can be guaranteed.

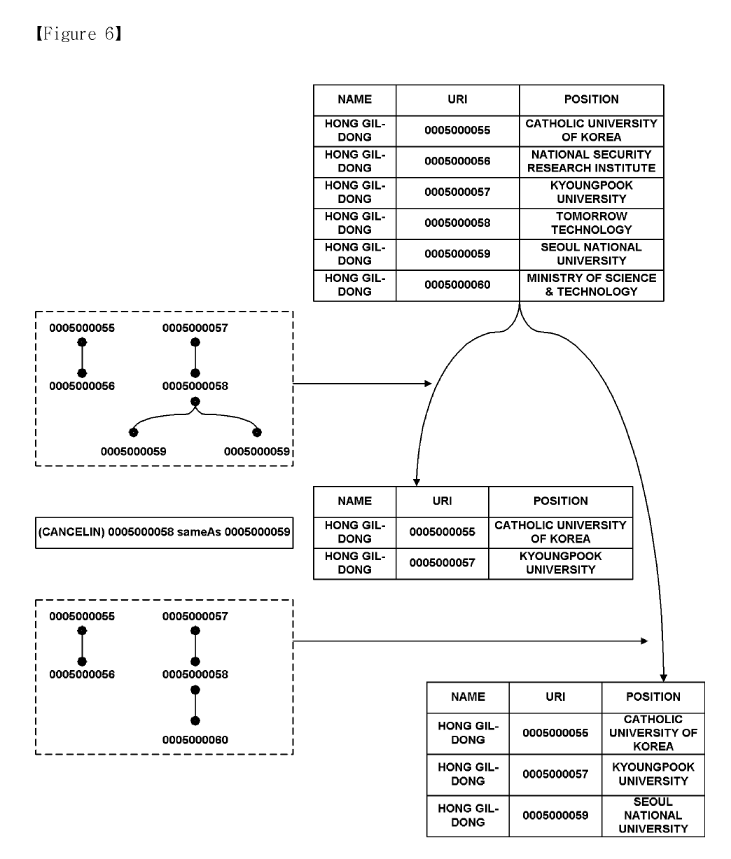

When an object bound in a sameAs relationship is found in individual objects shown in a query-processed result, the sameAs post-processing section 32 substitutes the object with an URI of a representative object of a sameAs group to which the object belongs (refer to FIG. 6).

The construction of the invention will be arranged and described as follows.

1) SameAs Management System and Service Method

A method of managing sameAs relationships represented as a triple, a method of changing knowledge of a sameAs group, and a method of performing sameAs post-processing on a query-processed result.

2) SameAs Relationship Management Method

A method of checking a sameAs relationship and a method of setting and canceling a sameAs relationship.

3) SameAs Group Knowledge Processing Method

A method of setting and canceling knowledge of a sameAs group.

4) Inference Service Method

A method in which sameAs post-processing is performed on a query-processed result from a user query so as to create an inference result.

5) Method of Configuring Semantic Web Application Service Using SameAs Management Service

A method of configuring a Semantic-Web application service by using the overall system or some systems shown in FIG. 1.

While the present invention has been described with reference to exemplary embodiments thereof, it will be understood by those skilled in the art that various changes and modifications in form and detail may be made therein without departing from the scope of the present invention as defined by the following claims.

1. A system for managing sameAs relationships between ontology instances, the system comprising:
a sameAs relationship managing unit that checks, sets, or cancels sameAs relationships between ontology instances;
a sameAs group knowledge processing unit that receives an input for setting or canceling sameAs relationships from the sameAs relationship managing unit and then corrects related knowledge within ontology instance data; and
a sameAs inference service providing unit that uses the knowledge corrected by the sameAs group knowledge processing unit, processes a user query, and performs sameAs post-processing so as to present the result.

2. The system according to claim 1,
wherein the sameAs relationship managing unit includes:
a sameAs relationship checking section that checks sameAs object pairs and sameAs groups, which are obtained from the sameAs relationships set within ontology;
a sameAs relationship setting section that sets a new sameAs relationship on an arbitrary object pair; and
a sameAs relationship canceling section that cancels the sameAs relationship set by the sameAs relationship setting section.

3. The system according to claim 2,
wherein the sameAs relationship checking section provides a screen interface for searching object pairs in which sameAs relationships are already set; a screen interface for outputting sameAs object pairs; a screen interface for outputting objects bound in a sameAs relationship for each sameAs group; and a screen interface for displaying a URI (Uniform Resource Locator) of a sameAs object such that the domain of the object bound in the sameAs relationship can be checked.

4. The system according to claim 2,
wherein the sameAs relationship setting section provides a screen interface for receiving URIs of two objects, which are to establish a sameAs relationship, from a user and outputting a relationship between the objects or attributes of the objects such that the identity of a sameAs candidate object can be checked; a screen interface for designating a representative object among the sameAs candidate objects which are inputted by the user; a screen interface for verifying whether or not the consistency of ontology instances is broken when the sameAs candidate objects inputted by the user are bound in a sameAs relationship and then outputting the result; and a screen interface for outputting an appropriate error message with respect to an inappropriate request of a user for the setting of sameAs relationship, and generates a sameAs triple in which an object designated as a representative object among the sameAs candidate objects inputted by the user is set to a subject of the sameAs relationship and the other objects are set to objects.

5. The system according to claim 2,
wherein the sameAs relationship canceling section provides a screen interface for selecting a sameAs object pair, of which the sameAs relationship is to be canceled, among the sameAs object pairs in which the sameAs relationships are already established by the sameAs relationship checking section and then outputting a relationship between two objects of the selected sameAs object pair or attributes of the objects such that the identities of objects between which the sameAs relationship is to be broken can be checked; and a screen interface for verifying whether or not the consistency of ontology instances is broken when the sameAs relationship of the sameAs object pair inputted by a user is canceled and then outputting the result, and eliminates a sameAs triple related to the sameAs object pair of which the sameAs relationship is to be canceled.

6. The system according to claim 1,
wherein the sameAs group knowledge processing unit includes:
a sameAs group knowledge setting section that corrects the knowledge of a representative object of a sameAs group which is changed when the sameAs relationship setting section of the sameAs relationship managing unit sets a new sameAs relationship; and
a sameAs group knowledge canceling section that corrects the knowledge of a representative object of a sameAs group which is changed when the sameAs relationship canceling section of the sameAs relationship managing unit cancels a sameAs relationship.

7. The system according to claim 6,
wherein the sameAs group knowledge setting section receives an input of sameAs objects (designated as A and B in this sentence) and a sameAs representative object (designated as A in this sentence), which are converted into a sameAs triple by the sameAs relationship setting section, searches representative objects of sameAs groups to which A and B respectively belong, and accumulates some of attributes owned by a representative object of the group to which B belongs into corresponding attributes of a representative object of the group to which A belongs, because of the sameAs grouping.

8. The system according to claim 6,
wherein the sameAs group knowledge canceling section receives an input of sameAs objects (designated as A and B in this sentence), between which the sameAs relationship is canceled by the sameAs relationship canceling section, and a representative object (corresponding to a subject of a sameAs triple and designated as A in this sentence) when the sameAs relationship is set, searches representative objects of the sameAs groups to which A and B respectively belong, and subtracts some of attributes owned by a representative object of the group to which B belongs from corresponding attributes of a representative object of the group to which A belongs, because of the cancellation of sameAs grouping.

9. The system according to any one of claims 1 to 8,
wherein the sameAs inference service providing unit includes:
a query processing section that processes a user query;
a sameAs post-processing section that performs sameAs post-processing on the query-processed result from the query processing section; and
a result presenting section that processes the sameAs post-processing result into a format to be requested in an inference service interface and then outputs the result.

10. The system according to claim 9,
wherein the sameAs post-processing section searches a sameAs group connected in the sameAs relationship with respect to individual objects shown in the query-processed result from the query processing section, searches a representative object of the sameAs group, and substitutes the objects with the representative object.

11. A method for managing sameAs relationships between ontology instances, the method comprising:
checking, setting, or canceling sameAs relationships between ontology instances;
receiving an input for the setting or canceling of the sameAs relationships and then correcting related knowledge within ontology instance data; and
using the corrected knowledge, processing a user query, and performing sameAs post-processing so as to present the result.

12. The method according to claim 11,
wherein the checking, setting, or canceling of the sameAs relationships includes:
checking sameAs object pairs and sameAs groups to be obtained from sameAs relationships which are already set within ontology;
setting a new sameAs relationship on an arbitrary object pair; and
canceling the sameAs relationship of the sameAs object pair which is already set.

13. The method according to claim 12,
wherein in the checking of the sameAs object pairs and sameAs groups, there are provided a screen interface for searching object pairs in which sameAs relationships are already set; a screen interface for outputting sameAs object pairs; a screen interface for outputting objects bound in a sameAs relationship for each sameAs group; and a screen interface for displaying a URI of a sameAs object such that the domain of the object bound in a sameAs relationship can be checked.

14. The method according to claim 12,
wherein in the setting of the new sameAs relationship, a new sameAs relationship is set on an arbitrary object pair or sameAs groups to which two objects respectively belong.

15. The method according to claim 12,
wherein in the canceling of the sameAs relationship, the sameAs relationship of the sameAs object pair which is already set is canceled.

16. The method according to claim 11,
wherein the receiving of the input for the setting or canceling of the sameAs relationships includes:
receiving an input for setting the sameAs relationship of an object pair and then correcting knowledges related to two objects which are to establish a sameAs relationship; and
receiving an input for canceling the sameAs relationship of an object pair and then correcting knowledges related to two objects between which the sameAs relationship is to be canceled.

17. The method according to claim 16,
wherein in the receiving of the input for setting the sameAs relationship, an input of the sameAs relationship of an object pair is received so as to search representative objects of sameAs groups with respect to two objects which are to establish a sameAs relationship, and knowledges related to the searched representative objects of the sameAs groups are corrected.

18. The method according to claim 16,
wherein in the receiving of the input for canceling the sameAs relationship, an input for canceling the sameAs relationship of an object pair is received so as to search representative objects of sameAs groups with respect to two objects which are to cancel a sameAs relationship, and knowledges related to the searched representative objects of the sameAs groups are corrected.

19. The method according to any one of claims 11 to 18,
wherein the using of the corrected knowledge, the processing of the user query, and the performing of the sameAs post-processing includes:
receiving a user query so as to generate the query-processed result;
searching a sameAs group connected in a sameAs relationship with respect to individual objects shown in the query-processed result, searching a representative object of the sameAs group, and substituting the objects with the searched representative object; and
receiving the result of the previous step and then generating an output message such that the output message is fitted to a user interface.

20. The method according to claim 19,
wherein in the searching of the sameAs group, a sameAs group connected in the sameAs relationship with respect to individual objects shown in the query-processed result is searched, a representative object of the sameAs group is searched, and the objects of the query-processed result are substituted with the searched representative object.
